(19) United States
(12) Patent Application Publication
(10) Pub. No.: US 2024/0203614 A1
(43) Pub. Date: Jun. 20, 2024

(54) TARGET AND TARGET GROUP USED FOR HEAVY WATER REACTOR PRODUCTION OF C-14 ISOTOPES

(71) Applicant: Shanghai Nuclear Engineering Research & Design Institute Co., LTD., Shanghai (CN)

(72) Inventors: Yu DANG, Shanghai (CN); Xiangyang CHEN, Shanghai (CN); Bo LI, Shanghai (CN); Yu HAN, Shanghai (CN); Junqiang LU, Shanghai (CN); Yunqing ZHOU, Shanghai (CN); Chuntao TANG, Shanghai (CN); Qing YE, Shanghai (CN)

(73) Assignee: Shanghai Nuclear Engineering Research & Design Institute Co., LTD., Shanghai (CN)

(21) Appl. No.: 18/555,354

(22) PCT Filed: Apr. 18, 2022
(86) PCT No.: PCT/CN2022/087317

§ 371 Date: Oct. 13, 2023

(30) Foreign Application Priority Data
Apr. 16, 2021 (CN) 202110413679.7

(51) Int. Cl. G21G 1/00; G21G 1/02

(52) U.S. Cl. CPC G21G 1/001; G21G 1/02; G21G 2001/0094

(57) ABSTRACT

A target used for heavy water reactor production of C-14 isotopes, which comprises: a target tube, which has a target material and/or an absorber material, the target material being a nitrogen-containing solid material; end plates, which are arranged at two ends of the target tube; a connection rod, which is provided with a connection component that is connected to a positioning mechanism used for positioning the target, wherein the connection rod passes through the target tube along the axial direction of the target tube, and the target tube is fixedly connected to the connection rod by means of the end plates. The present invention can be adapted to be placed at different locations such as at a guide tube, an inspection passage, or a fuel channel to undergo irradiation and produce C-14 isotopes.

### TECHNICAL FIELD

The present invention relates to the technical field of radioactive isotope production, and in particular to a target used in a heavy water reactor for producing C-14 isotopes.

### BACKGROUND

C-14 is a pure β radioisotope, which can be used to form carbon labelled compounds for detecting and tracing and is widely used in agriculture, industry, medicine, and biological sciences. In 2009, the annual market demand for C-14 reached 1000-2000 Ci. On one hand, there has been a shortage in the supply of C-14 radioactive sources since 2010, with prices rising 5-10 times over the past six years; and on the other hand, the market demand for C-14 labelling is increasing, for example, many countries including China have begun to require that new drugs and even generic drugs must undergo C-14 pharmacokinetic analysis.

Therefore, it is of great significance and value to design and produce targets for producing C-14 isotopes to improve the yield of C-14 according to the current situation in China.

### SUMMARY

The present invention provides a target used in a heavy water reactor for producing C-14 isotopes, which has simple structure, is easy to process and manufacture, and can realize the industrialized production of C-14 isotopes.

A target used in a heavy water reactor for producing C-14 isotopes according to the present invention includes: a target tube, which has a target material and/or an absorber material, the target material being a solid material containing nitrogen elements; end plates, which are arranged at two ends of the target tube; and a connection rod, which is provided with a component that is connected to a positioning mechanism used for positioning the target, wherein the connection rod passes through the target tube along an axial direction of the target tube, and the target tube is fixedly connected to the connection rod by means of the end plates.

Preferably, the target tube further includes a cladding which has filling openings for filling the target material and/or the absorber material, and the target material and/or the absorber material are filled in the cladding.

Preferably, the target tube is formed by arranging a plurality of single target tubes around the connection rod circumferentially. Each of the single target tubes includes the cladding: the single target tube further includes end plugs that cover the filling openings at the ends of the cladding and are in sealed connection with the cladding; and the target material is filled in a sealed cavity defined by the end plugs and the cladding.

Preferably, the target further includes:

an absorbing rod made of an absorber material, wherein two ends of the absorbing rod are fixed by the end plates, wherein the target tube is formed by arranging a plurality of absorbing rods and the plurality of single target tubes around the connection rod circumferentially.

Preferably, the target tube is an annular target tube, the end plates are in sealed connection with the cladding, and the target material and/or the absorber material are filled in a sealed cavity defined by the end plates and the cladding.

Preferably, the target tube is an annular target tube made of the absorber material.

Preferably, the cladding of the annular target tube includes an inner cladding and an outer cladding, and the inner cladding is connected to the connection rod through ribs.

Preferably, the outer cladding includes a first outer cladding and a second outer cladding; the inner cladding includes a first inner cladding and a second inner cladding; and the end plates includes inner end plates and outer end plates;

the first outer cladding is arranged on an inner side of the second outer cladding, the second inner cladding is arranged on an inner side of the first outer cladding, and the first inner cladding is arranged on an inner side of the second inner cladding; the inner end plates cover ends of the first inner cladding and the second inner cladding and are in sealed connection with the first inner cladding and the second inner cladding, and the target material is filled in a sealed cavity defined by the inner end plates, the first inner cladding, and the second inner cladding; the outer end plates cover ends of the first outer cladding and the second outer cladding and are in sealed connection with the first outer cladding and the second outer cladding, and the absorber material is filled in a sealed cavity defined by the outer end plates, the first outer cladding, and the second outer cladding; connecting ribs are provided between the first outer cladding and the second inner claddings; and the connection rod is fixedly connected to the inner end plates, and the first inner cladding is connected to the connection rod through ribs.

Preferably, the absorber material is filled in the sealed cavity defined by the inner end plates, the first inner cladding, and the second inner cladding, and the target material is filled in the sealed cavity defined by the outer end plates, the first outer cladding, and the second outer cladding.

Preferably, the absorber material is one of absorber materials with a neutron absorption value higher than that of stainless steel or a combination of the absorber materials.

Preferably, the end plug and the cladding are made of a material including one or more selected from a group consisting of zirconium and zirconium-based alloy, aluminum and aluminum-based alloy, quartz glass, nickel-based alloy, and stainless steel.

The present invention further provided a target set used in a heavy water reactor for producing C-14 isotopes, which is formed by connecting a plurality of targets according to any of the above embodiments in series.

In the present invention, the target or the target set is placed in a core of a heavy water reactor to generate C-14 isotopes by means of the irradiation of thermal neutrons, and structures of the target and the target set are improved as required, so that the target and the target set can be adapted to be placed at different locations such as in a guide tube, an inspection passage, or a fuel channel to undergo irradiation so as to produce C-14 isotopes. By adopting the present invention, the industrial production of C-14 isotopes can be realized, which helps to increase production capacity of C-14, so as to promote the development of industries such as biomedicine, environmental protection, and isotope labeling detection.

### BRIEF DESCRIPTION OF THE DRAWINGS

In order to more clearly illustrate the technical scheme of the embodiments of the present application, the accompanying drawings to be used in the embodiments of the present application are briefly introduced below. Apparently, the accompanying drawings described below are only some embodiments of the present application, and those skilled in the art can obtain other drawings according to the accompanying drawings without making creative efforts.

FIG. 1 is a schematic structural diagram of a single target tube according to an embodiment of the present invention;

FIG. 2 is a schematic structural diagram of a target according to an embodiment of the present invention;

FIG. 3 is a schematic structural diagram of a target set defined by connecting the targets shown in FIG. 2 of the present invention in series;

FIG. 4 is a schematic structural diagram of a target with an annular target tube according to an embodiment of the present invention;

FIG. 5 is a schematic cross-sectional view of the structure shown in FIG. 4 of the present invention;

FIG. 6 is a schematic structural diagram of a target with a double-layer annular target tube according to an embodiment of the present invention;

FIG. 7 is a schematic cross-sectional view of the structure shown in FIG. 6 of the present invention; and

FIG. 8 is a schematic structural diagram of a target set defined by connecting the targets shown in FIG. 6 of the present invention in series.

In the drawings, each drawing is not drawn to scale.

### REFERENCE NUMBERS

1—Single target tube;
   11—Target material
   12—End plug
   13—Cladding
      131—Inner cladding
         131a—First inner cladding
         131b—Second inner cladding
      132—Outer cladding
         132a—First outer cladding
         132b—Second outer cladding
   14—Absorber material
2—End plate
   2a—Inner end plate
   2b—Outer end plate
3—Connection rod
   31—Wire rope
4—Rib

### DETAILED DESCRIPTION

The implementation manner of the present application will be further described in detail below with reference to the drawings and embodiments. The detailed description and drawings of the following embodiments are used to illustrate the principles of the present application by way of example, but not to limit the scope of the present application, that is, the present application is not limited to the described embodiments.

In the description of this application, it should be noted that unless otherwise specified, the meaning of “plurality of” is more than two; the orientation or positional relationship indicated by the terms “upper”, “lower”, “left”, “right”, “inside”, “outside” and so on are only for the convenience of describing the present application and simplifying the description, rather than indicating or implying that the device or element referred to must have a specific orientation, be constructed and operated in a specific orientation, and therefore cannot be understood as restrictions on this application. In addition, the terms “first”, “second”, “third”, etc. are used for descriptive purposes only and should not be construed as indicating or implying relative importance.

The orientation terms appearing in the following description are the directions shown in drawings, and do not limit the specific structure of the present application. In the description of this application, it should also be noted that unless otherwise specified and limited, the terms “installation”, “connection” and “coupling” should be understood in a broad sense, for example, it can be a fixed connection, a detachable connection, or an integral connection; or it can be a direct connection or indirect connection through an intermediary. For those of ordinary skill in the art, the specific meanings of the above terms in this application can be understood according to specific situations.

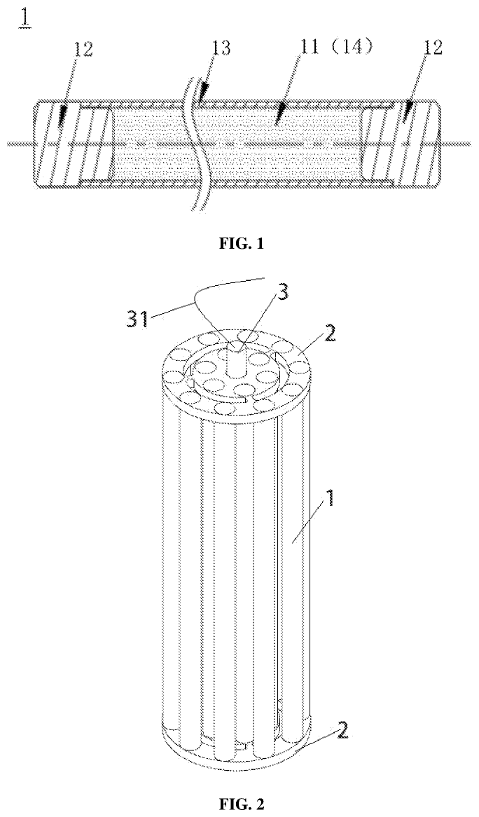

FIG. 1 is a schematic structural diagram of a single target tube 1 according to an embodiment of the present invention, and FIG. 2 is a schematic structural diagram of a target according to an embodiment of the present invention. Referring to FIG. 1 and FIG. 2, the target used in a heavy water reactor for producing C-14 isotopes according to the present invention includes: a target tube, which has a target material 11 and/or an absorber material 14, the target material 11 being a solid material containing nitrogen elements; end plates 2, which are arranged at two ends of the target tube; and a connection rod 3, which is provided with a connection component that is connected to a positioning mechanism used for positioning the target. The connection component may be the wire rope 31 as shown in FIG. 2. The connection rod 3 passes through the target tube along the axial direction of the target tube, and the target tube is fixedly connected to the connection rod 3 by means of the end plates 2. When the target tube needs to be placed in a guide tube of a heavy water reactor, at least part of the target tube needs to contain the absorber material 14; and when the target tube is placed outside the guide tube of the heavy water reactor, it may not contain the absorber material 14. The purpose of adopting the absorber material 14 is that, when the target shown in FIG. 2 needs to be placed in the guide tube of the heavy water reactor, the target placed in the guide tube of the heavy water reactor further needs to have a function of an adjustment rod assembly which is generally placed in the guide tube of the heavy water reactor for absorbing neutrons and adjusting core reactivity, in order not to affect the neutron adjustment function of the guide tube of the heavy water reactor while producing C-14 isotopes by the target placed here. Therefore, one of absorber materials 14 such as cobalt, tungsten, silver-indium-cadmium alloy, hafnium, boron carbide, etc., with neutron absorption values higher than that of stainless steel (i.e., absorber materials with thermal neutron absorption cross-sections larger than that of stainless steel material) or a combination thereof is packaged in the cladding 13 to make a structure similar to that of the single target tube 1 in FIG. 1, or is directly made into a rod as an absorbing rod to replace part of the single target tube 1 and be connected with the end plates 2 in case that the absorber material 11 does not need to be packaged by the cladding 13, and can be used to absorb neutrons to ensure that the neutron absorption value of the target is equivalent to that of the original adjustment rod assembly. Preferably, the cladding 13 may be a double-layer cladding, which can improve safety.

In some embodiments, the target tube further includes a cladding 13 which has filling openings at ends thereof for filling the target material 11 and/or the absorber material 14, and the target material 11 and/or the absorber material 14 are filled in the cladding 13.

In some embodiments, the target tube is defined by arranging several single target tubes around the connection rod 3 circumferentially, each of the single target tubes 1 includes the cladding 13; the single target tube 1 further includes end plugs 12 that cover the filling openings at the ends of the cladding 13 and is in sealed connection with the cladding 13; and the target material 11 is filled in a sealed cavity defined by the end plugs 12 and the cladding 13. As shown in FIG. 1, in some embodiments, the single target tube 1 includes a target material 11, end plugs 12, and a cladding 13, a cavity is defined by connecting the end plugs 12 with the cladding 13 in a sealed manner through welding or other manners, and the target material 11 is filled in the cavity. The target material 11 may be a solid material containing nitrogen elements. In addition to nitrogen elements, the solid material may further contain elements such as Ca, Ba, Mg. Al, Si and other elements with thermal neutron absorption microscopic capture cross-sections that do not exceed 1 barn (2200 m/s) or a mixture thereof, so as to limit absorption capture cross-sections of impurity elements to avoid affecting the absorption of neutrons by the target material 11. Regarding the material of the target material 11, the end plugs 12 and the cladding 13 may be made of materials containing one or more of zirconium and zirconium-based alloys, aluminum and aluminum-based alloys, quartz glass, nickel-based alloys, or stainless steel in a content greater than 50%.

As shown in FIG. 2, in some embodiments, the target includes a single target tube 1; the single target tube 1 includes end plugs 12, the cladding 13, and the target material 11; the cladding 13 has filling openings at ends thereof for filling the target material 11; the target material 11 is a solid material containing nitrogen elements; the end plugs 12 cover the filling openings at the ends of the cladding 13 and are in sealed connection with the cladding 13; the target material 11 is filled in a sealed cavity defined by the end plugs 12 and the cladding 13; the target further includes end plates 2 and a connection rod 3, and the connection rod 3 is provided with a connection component, such as a wire rope 31, etc., that is connected to a positioning mechanism used for positioning the target; and several single target tubes 1 are arranged around the connection rod 3, and both ends of the single target tube 1 and the connection rod 3 are fixed by the end plates 2. The single target tube 1 and the end plates 2 are connected to each other by means of welding, threaded connection, or snap-fit connection. The connection rod 3 and the end plates 2 are connected to each other by means of welding, threaded connection, or snap-fit connection.

In some embodiments, the target further includes an absorbing rod (not shown in figures) made of the absorber material 14, and two ends of the absorbing rod are fixed by the end plates 2. The target is defined by arranging a plurality of absorbing rods and a plurality of single target tubes 1 around the connection rod 3 circumferentially, and the absorbing rods and the single target tubes 1 can be arranged at intervals or in other forms.

In some embodiments, a head of the connection rod 3 is installed with a wire rope 31, which can be connected to an adjustment rod driving mechanism in the heavy water reactor to position the target. The wire rope 31 can be connected to the connection rod 3 in many manners, for example: the wire rope 31 is connected to the connection rod 3 through a connecting nut (not shown in figures), one end of the wire rope 31 has a ball head embedded in the connecting nut and movably connected to the connecting nut, and the connecting nut is screwed with the connection rod 3.

FIG. 4 is a schematic structural diagram of a target with an annular target tube according to an embodiment of the present invention, and FIG. 5 is a schematic cross-sectional view of the structure shown in FIG. 4 of the present invention. As shown in FIG. 4 and FIG. 5, in some embodiments, the target tube is an annular target tube, the end plates 2 are in sealed connection with the cladding 13, and the target material 11 and/or the absorber material 14 are filled in a sealed cavity defined by the end plates 2 and the cladding 13.

In some embodiments, the target tube is an annular target tube made of the absorber material 14. Preferably, the absorber material 14 of the annular target tube may also be integrally molded into an annular absorber, two ends of the annular absorber are fixed by the end plates 2, and the target is defined by sleeving the annular absorber on the connection rod 3.

In some embodiments, the cladding 13 of the annular target tube is divided into an inner cladding 131 and an outer cladding 132, and the inner cladding 131 is connected to the connection rod 3 through ribs 4.

As shown in FIGS. 4 and 5, in some embodiments, the target includes an inner cladding 131, an outer cladding 132, a connection rod 3, and end plates 2, and the target material 11 is filled in a sealed cavity defined by the end plates 2 and the two layers of cladding, i.e., the inner cladding 131 and the outer cladding 132, so as to constitute an annular target tube. The inner cladding 131 is connected to the connection rod 3 through the ribs 4. When the target shown in FIG. 4 and FIG. 5 needs to be placed in an inspection passage of the heavy water reactor, the target placed at this position does not need to have the function of the adjustment rod assembly, and does not need to be provided with absorbing rods or filled with the absorber material 14. The upper end of the connection rod 3 in the center of the target may be connected to the wire rope 31 to cooperate with a positioning mechanism arranged above core components to position the target, or the connection rod 3 directly positions the target.

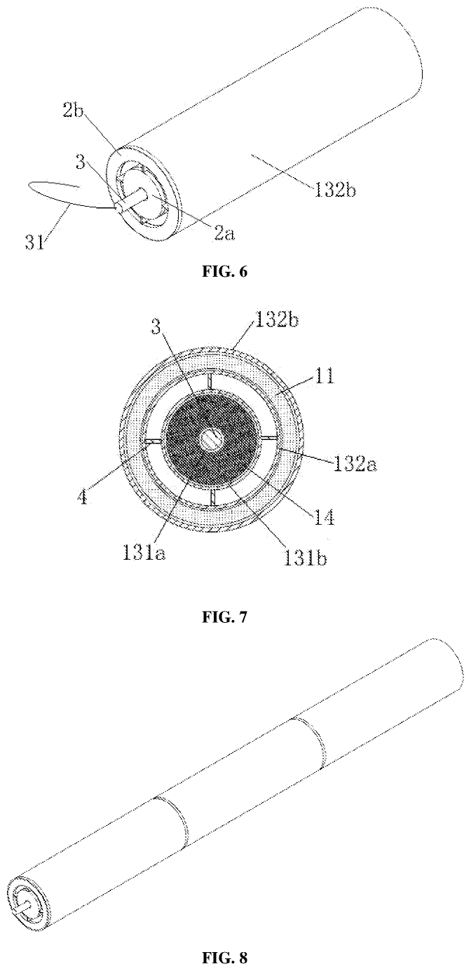

FIG. 6 is a schematic structural diagram of a target with a double-layer annular target tube according to an embodiment of the present invention, and FIG. 7 is a schematic cross-sectional view of the structure shown in FIG. 6 of the present invention. As shown in FIG. 6 and FIG. 7, the outer cladding 132 includes a first outer cladding 132a and a second outer cladding 132b, the inner cladding 131 includes a first inner cladding 131a and a second inner cladding 131b, and the end plates 2 include inner end plates 2a and outer end plates 2b. The first outer cladding 132a is arranged on the inner side of the second outer cladding 132b, the second inner cladding 131b is arranged on the inner side of the first outer cladding 132a, and the first inner cladding 131a is arranged on the inner side of the second inner cladding 131b. The inner end plates 2a cover ends of the first inner cladding 131a and the second inner cladding 131b and are in sealed connection with the first inner cladding 131a and the second inner cladding 131b, and the target material 11 is filled in a sealed cavity defined by the inner end plates 2a, the first inner cladding 131a and the second inner cladding 131b. The outer end plates 2b cover ends of the first outer cladding 132a and the second outer cladding 132b and are in sealed connection with the first outer cladding 132a, and the second outer cladding 132b, and the absorber material 14 is filled in a sealed cavity defined by the outer end plates 2b, the first outer cladding 132a, and the second outer cladding 132b. Connecting ribs are provided between the first outer cladding 132a and the second inner cladding 131b, the connection rod 3 is fixedly connected to the inner end plates 2a, and the first inner cladding 131a is connected to the connection rod 3 through the ribs 4.

In some embodiments, the absorber material 14 is filled in the sealed cavity defined by the inner end plates 2a, the first inner cladding 131a, and the second inner cladding 131b, and the target material 11 is filled in the sealed cavity defined by the outer end plates 2b, the first outer cladding 132a, and the second outer cladding 132b. The arrangement of the filling material in the inner cavity or outer cavity may be adjusted according to production needs. In one embodiment of the present invention, as shown in FIG. 8, the absorber material 14 is filled in the sealed cavity defined by the inner end plates 2a, the first inner cladding 131a, and the second inner cladding 131b, and the target material 11 is filled in the sealed cavity defined by the outer end plates 2b, the first outer cladding 132a, and the second outer cladding 132b. The target provided with the absorber material 14 is placed in the guide tube of the heavy water reactor, so that the absorber material 14 may further be used to absorb neutrons and adjust the reactivity of the core in production of C-14 without affecting the neutron adjustment function of the guide tube of the heavy water reactor.

In some embodiments, the absorber material 14 is one of absorber materials having a neutron absorption value higher than that of stainless steel, or a combination of the absorber materials.

In some embodiments, the end plug 12 and the cladding 13 are made of a material including one or more selected from a group consisting of zirconium and zirconium-based alloys, aluminum and aluminum-based alloys, quartz glass, nickel-based alloys, and stainless steel.

In one embodiment of the present invention, fuel elements in a fuel bundle of the heavy water reactor are replaced by the single target tubes 1 shown in FIG. 1, and the resulted fuel bundle can be put into a fuel channel of the heavy water reactor for producing C-14.

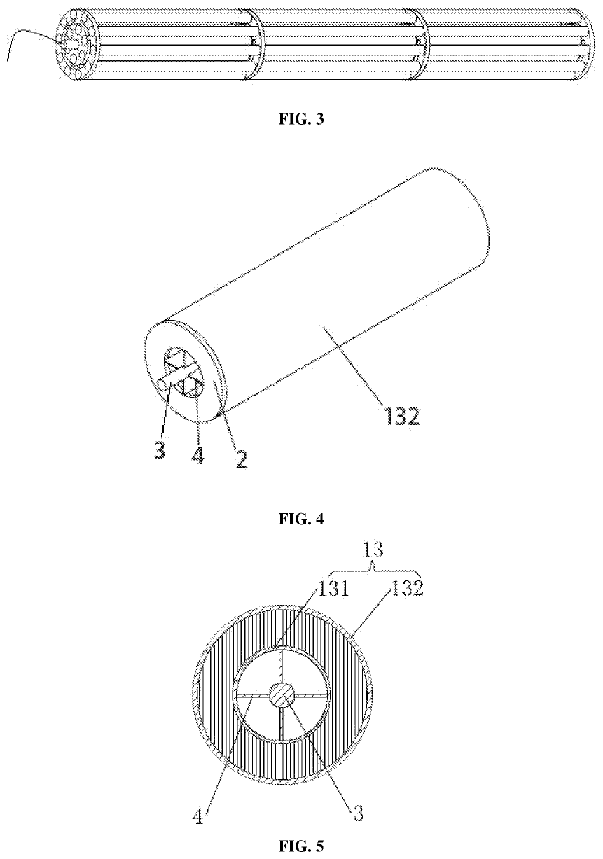

An embodiment of the present invention further provides a target set used in a heavy water reactor for producing C-14 isotopes. The target set is formed by connecting a plurality of targets according to any above-mentioned embodiment in series. For example, FIG. 3 is a schematic structural diagram of a target set formed by connecting a plurality of targets shown in FIG. 2 of the present invention in series. The plurality of targets shown in FIG. 2 are stacked in series to form the structure of the target set shown in FIG. 3, wherein the connection rods 3 of the plurality of targets can be connected together in series, or the connection rods 3 of the plurality of targets can be integrally molded, i.e., the plurality of targets may be connected in series by the same connection rod 3 to form a target set. FIG. 8 is a schematic structural diagram of a target set formed by connecting a plurality of targets shown in FIG. 6 of the present invention in series, and the plurality of targets shown in FIG. 6 may be stacked in series to form the structure shown in FIG. 8.

For the target and target set used in a heavy water reactor for producing C-14 isotopes according to the present invention, by adding the absorber material 11 or the absorbing rod and the connection rod 3, the target and the target set can be placed in the guide tube of the heavy water reactor; by arranging a connection rod assembly, the target and the target set can be placed in the inspection passage; and by replacing fuel elements in the fuel bundle of the heavy water reactor with the single target tubes 1, the target can be placed in the fuel channel. By improving the target and the target set in above various ways according to the present invention, the target and the target set can be placed in multiple positions in the heavy water reactor, and the space in the heavy water reactor can be fully utilized for producing C-14, thereby increasing the yield of C-14.

While the present application has been described with reference to preferred embodiments, various modifications may be made and components therein may be replaced by equivalents without departing from the scope of the present application. In particular, as long as there is no structural conflict, the technical features mentioned in the various embodiments can be combined in any manner. The present application is not limited to the specific embodiments disclosed herein, but includes all technical solutions falling within the scope of the claims.

1. A target used in a heavy water reactor for producing C-14 isotopes, comprising:
a target tube, which has a target material and/or an absorber material, the target material being a solid material containing nitrogen elements;
end plates, which are arranged at two ends of the target tube; and
a connection rod, which is provided with a connection component that is connected to a positioning mechanism used for positioning the target,
wherein the connection rod passes through the target tube along an axial direction of the target tube, and the target tube is fixedly connected to the connection rod by means of the end plates.

2. The target used in the heavy water reactor for producing C-14 isotopes according to claim 1, wherein the target tube further comprises a cladding which has filling openings at ends thereof for filling the target material and/or the absorber material, and the target material and/or the absorber material are filled in the cladding.

3. The target used in the heavy water reactor for producing C-14 isotopes according to claim 2, wherein the target tube is formed by arranging a plurality of single target tubes around the connection rod circumferentially, wherein each of the single target tubes comprises the cladding; the single target tube further comprises end plugs that cover the filling openings at the ends of the cladding and are in sealed connection with the cladding; and the target material is filled in a sealed cavity defined by the end plugs and the cladding.

4. The target used in the heavy water reactor for producing C-14 isotopes according to claim 3, further comprising:
an absorbing rod made of an absorber material, wherein two ends of the absorbing rod are fixed by the end plates, wherein the target tube is formed by arranging a plurality of absorbing rods and the plurality of single target tubes around the connection rod circumferentially.

5. The target used in the heavy water reactor for producing C-14 isotopes according to claim 2, wherein the target tube is an annular target tube, the end plates are in sealed connection with the cladding, and the target material and/or the absorber material are filled in a sealed cavity defined by the end plates and the cladding.

6. The target used in the heavy water reactor for producing C-14 isotopes according to claim 1, wherein the target tube is an annular target tube made of the absorber material.

7. The target used in the heavy water reactor for producing C-14 isotopes according to claim 5, wherein the cladding of the annular target tube comprises an inner cladding and an outer cladding, and the inner cladding is connected to the connection rod through ribs.

8. The target used in the heavy water reactor for producing C-14 isotopes according to claim 7, wherein the outer cladding comprises a first outer cladding and a second outer cladding; the inner cladding comprises a first inner cladding and a second inner cladding; and the end plates comprise inner end plates and outer end plates,
wherein the first outer cladding is arranged on an inner side of the second outer cladding, the second inner cladding is arranged on an inner side of the first outer cladding, and the first inner cladding is arranged on an inner side of the second inner cladding; the inner end plates cover ends of the first inner cladding and the second inner cladding and are in sealed connection with the first inner cladding and the second inner cladding, and the target material is filled in a sealed cavity defined by the inner end plates, the first inner cladding, and the second inner cladding; the outer end plates cover ends of the first outer cladding and the second outer cladding and are in sealed connection with the first outer cladding and the second outer cladding, and the absorber material is filled in a sealed cavity defined by the outer end plates, the first outer cladding, and the second outer cladding; connecting ribs are provided between the first outer cladding and the second inner cladding; and the connection rod is fixedly connected to the inner end plates, and the first inner cladding is connected to the connection rod through ribs.

9. The target used in the heavy water reactor for producing C-14 isotopes according to claim 8, wherein the absorber material is filled in the sealed cavity defined by the inner end plates, the first inner cladding, and the second inner cladding, and the target material is filled in the sealed cavity defined by the outer end plates, the first outer cladding, and the second outer cladding.

10. The target used in the heavy water reactor for producing C-14 isotopes according to claim 1, wherein the absorber material is one of absorber materials with a neutron absorption value higher than that of stainless steel or a combination of the absorber materials.

11. The target used in the heavy water reactor for producing C-14 isotopes according to claim 3, wherein the end plugs and the cladding are made of a material comprising one or more selected from a group consisting of zirconium and zirconium-based alloy, aluminum and aluminum-based alloy, quartz glass, nickel-based alloy, and stainless steel.

12. A target set used in a heavy water reactor for producing C-14 isotopes, the target set being formed by connecting a plurality of targets according to claim 1 in series.
